(19) United States
(12) Patent Application Publication
(10) Pub. No.: US 2017/0055524 A1
(43) Pub. Date: Mar. 2, 2017

(54) Aqueous Adjuvant Composition For Increasing The Efficacy Of Electrolyte Active Substances

(71) Applicant: Clariant International Ltd., Muttenz (CH)

(72) Inventors: Peter BAUR, Schondorf (DE); Peter KLUG, Grossostheim (DE); Roland ARNOLD, Elbtal (DE); Peter MANSOUR, Wiesbaden (DE)

(73) Assignee: Clariant International Ltd., Muttenz (CH)

(21) Appl. No.: 15/120,103

(22) PCT Filed: Feb. 19, 2015
(86) PCT No.: PCT/EP2015/000370

§ 371 Date: Aug. 18, 2016

(30) Foreign Application Priority Data
Feb. 19, 2014 (DE) 102014203031.5
Apr. 30, 2014 (DE) 102014208252.8

(51) Int. Cl. A01N 25/30; A01N 39/04; A01N 43/66; A01N 41/10; A01N 41/12; A01N 43/54; A01N 37/38; A01N 37/40

(52) U.S. Cl. CPC A01N 25/30; A01N 37/38; A01N 39/04; A01N 37/40; A01N 41/10; A01N 41/12; A01N 43/54; A01N 43/66

(57) ABSTRACT

An adjuvant composition containing a) one or more alkyl glucamides of the formula (I), wherein R1 represents a linear or branched alkyl group having 5 to 9 carbon atoms, R2 represents an alkyl group having 1 to 3 carbon atoms; b) at least one water-soluble ammonium salt, preferably selected from the group consisting of ammonium sulfate, ammonium nitrate, ammonium nitrate urea, ammonium phosphate, ammoniumeitrate, ammonium chloride, and ammonium thiosulfate; c) propylene glycol, dipropylene glycol, mixtures of propylene glycol and dipropylene glycol, in each case optionally in a mixture with polypropylene glycol and/or polyethylene glycol, in each case with up to 10 repeating units; and d) water is suitable for increasing the efficacy of electrolyte active substances.

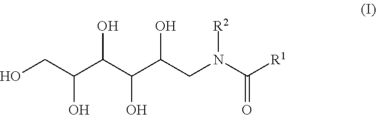

The invention relates to an aqueous adjuvant composition comprising alkylglucamides, to the use thereof for enhancing the action of electrolyte active ingredients, and to aqueous pesticide compositions comprising the adjuvant composition.

Pesticides (particularly herbicides, fungicides and insecticides) are chemical substances, prepared synthetically or of natural origin, which penetrate into plant cells or tissue or into parasitic organisms in or on the plant and damage and/or destroy them. The majority of pesticides are herbicides. Pesticides are typically used in the form of liquid or solid concentrated preparations (formulations) in agriculture. These are easier for the user to handle or ensure higher efficacy of the active ingredient. The formulations are typically diluted with water prior to use and then deployed by spray application.

Water-soluble concentrates (soluble liquids, abbreviated to SL) are an important form of pesticide preparations. They play a major role particularly in the case of herbicides, pesticides often being used in the form of water-soluble salts which are converted to their alkali metal or ammonium salts by neutralization of the acid form of the herbicides with suitable bases. Under some circumstances, a second water-insoluble active ingredient is present in the pesticide preparation. In that case, the preparation is a suspension concentrate (SC), even when an active ingredient is dissolved in the aqueous phase.

A particularly important role is played by the water-soluble salts of herbicides, for example of glyphosate or glufosinate or of the auxin herbicides such as 2,4-D or dicamba. They are preferably used as the alkali metal salt or in the form of various ammonium salts or as a mixture of these salts, usually as aqueous formulations.

It is a general problem in the application of pesticides that only a fraction of the active ingredient displays the desired activity. The greater portion is often lost unutilized, in that the active ingredient does not reach the leaves or roots of the plant on deployment of the spray liquor, but seeps away unutilized in the soil, is washed away by rain or is simply not properly absorbed by the plant.

This ecological and economic drawback can be reduced by addition of auxiliaries, referred to in the art as “adjuvant(s)”, to pesticide formulations. These auxiliaries can, for example, reduce spray drift, improve the wetting of the plant or ensure that the active ingredient sticks on the plant surface for longer or is better absorbed. Especially in the case of water-soluble pesticides, such as glyphosate, the type and amount of the adjuvants used have a crucial influence on the efficacy of the formulation.

By far the most commonly used adjuvants in aqueous herbicide formulations are fatty amine ethoxylates, mainly tallowamine ethoxylates. However, these products are a cause for concern because of their toxic and ecotoxicological properties, such as severe eye irritation or toxicity toward aquatic organisms, and are increasingly being replaced by adjuvants having a better toxicological and ecotoxicological profile.

Adjuvants which are used in aqueous pesticide formulations are typically in liquid form, i.e. in the form of water-miscible solutions, in order to simplify the production of the pesticide formulation. The adjuvant solutions may comprise water and/or water-miscible solvents which, together with the pesticide, give rise to a homogeneous and storage-stable aqueous formulation. If possible, water is used as solvent, since it is preferable both for reasons of cost and from an environmental standpoint. If necessary, cosolvents capable of improving the solubility or stability are added.

The use of sugar-based surfactants such as alkyl-N-methylglucosamides, for example in cleaning compositions and cosmetic products, is described in the literature (F. W. Lichtenthaler, “Carbohydrates as Organic Raw Materials” in Ullmann's Encyclopedia of Industrial Chemistry, Wiley-VCH Verlag, 2010).

WO 96/16540 describes pesticide compositions comprising long-chain alkylamides which bear a polyhydroxycarbonyl substituent having at least three hydroxyl groups on the amide nitrogen. The examples describe emulsion concentrates, water-dispersible powders and granules of dodecyl-N-methylglucamide, dodecyltetradecyl-N-methylglucamide and cetylstearyl-N-methylglucamide.

The demands of adjuvants in aqueous pesticide compositions have grown steadily over the years. As well as high biological efficacy and safety, both from the user's point of view and from an environmental standpoint, more advantageous performance properties are increasingly being demanded. The adjuvants are to enable maximum loading of the formulation with the active ingredient and maximum compatibility with various active ingredients. The formulations have to be storage-stable and have minimum viscosity, in order to assure easier handling, and the maximum emptying of the container. Moreover, good miscibility and rapid dissolution capacity, also and particularly in cold water, in the mixing of the spray liquor is required.

The problem addressed was thus that of providing further aqueous adjuvant compositions that are highly effective, feature a very advantageous toxicological and ecological profile and have advantageous properties from a performance point of view. Further desirable properties of an adjuvant are the enhancement of the absorption of systemic active ingredients, wetting, solubilization and combinability with ammonium sulfate and electrolyte active ingredients, and excellent plant compatibility.

The problem is solved by a preferably monophasic aqueous adjuvant composition comprising
a) one or more alkylglucamides of the formula (I)

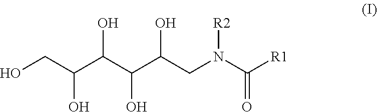

in which
R1 is a linear or branched alkyl group having 5 to 9 carbon atoms,
R2 is an alkyl group having 1 to 3 carbon atoms,
b) at least one water-soluble ammonium salt, preferably selected from the group consisting of ammonium sulfate, ammonium nitrate, ammonium nitrate urea, ammonium phosphate, ammonium citrate, ammonium chloride and ammonium thiosulfate,
c) propylene glycol, dipropylene glycol, mixtures of propylene glycol and dipropylene glycol, each optionally in a mixture with polypropylene glycol and/or polyethylene glycol, each having up to ten repeat units, and
d) water.

The invention further provides for the use of a composition of the invention as adjuvant for pesticide formulations.

The invention further provides a pesticide composition comprising the adjuvant of the invention.

The invention likewise provides a method of controlling harmful organisms, wherein the harmful organism or its habitat is brought into contact with a pesticide composition comprising the adjuvant composition of the invention.

The adjuvant composition of the invention especially increases the efficacy of electrolyte active ingredients, i.e. pesticides in the form of water-soluble salts.

In a preferred embodiment, the adjuvant composition, aside from water and propylene glycol, does not comprise any further solvents.

In a further preferred embodiment, the adjuvant composition consists of components a) to d).

As component a), the adjuvant composition comprises one or more alkylglucamides of the formula (I).

In the one or more alkylglucamide(s) of the formula (I), the R1 radical is preferably a linear or branched alkyl group having 7 to 9 carbon atoms. The R2 radical is preferably a methyl group.

More preferably, the adjuvant compositions of the invention comprise a mixture of octyl-N-methylglucamide (R1=C₇-alkyl, R2=methyl) and decyl-N-methylglucamide (R1=C₉-alkyl, R2=methyl). The proportion of octyl-N-methylglucamide in this mixture is 10% to 90% by weight, preferably 20% to 80% by weight and more preferably 30% to 70% by weight, based on the total amount of the alkylglucamides present in this mixture. The proportion of decyl-N-methylglucamide in this mixture is 10% to 90% by weight, preferably 20% to 80% by weight and more preferably 30% to 70% by weight, based on the total amount of the alkylglucamides present in this mixture. Preference is also given to nonyl-N-methylglucamide (R1=C₈-alkyl, R2=methyl, based on pelargonic acid).

The pentahydroxyhexyl radical in the alkylglucamides of the formula (I) has various chiral centers, such that several stereoisomers can exist in each case. Typically, the alkylglucamides of the formula (I) are prepared from naturally occurring sugars, such as D-glucose, but the use of other natural or synthetic hexoses or other C₆ units is also possible in principle, such that different stereoisomers of the formula (I) can result.

The preparation of the alkylglucamides of the formula (I) has been sufficiently well-described before and is known to the person skilled in the art. It is effected, for example, by condensation of carboxylic esters with a secondary N-alkylglucamine, which can in turn be prepared by reductive amination from a sugar such as D-glucose.

Preferably, the aqueous adjuvant compositions contain 5% to 90% by weight, more preferably 10% to 80% by weight and especially preferably 10% to 30% by weight of the one or more alkylglucamides of component a).

With the above-described alkylglucamides of the formula (I), it is possible to produce pesticide compositions of the invention, especially aqueous herbicide formulations, having excellent performance properties.

The alkylglucamides of the formula (I) are preferably based on renewable raw materials and feature an advantageous toxicological and ecological profile. They have a high solubility in water.

As component b), the adjuvant compositions comprise one or more and preferably one or two water-soluble ammonium salts, more preferably one water-soluble ammonium salt.

Preferred ammonium salts are ammonium sulfate, ammonium nitrate, ammonium nitrate urea, ammonium phosphate, ammonium citrate, ammonium thiosulfate and/or ammonium chloride, more preferably ammonium sulfate, ammonium nitrate, ammonium citrate and/or ammonium nitrate urea, most preferably ammonium sulfate.

Preferably, the adjuvant compositions contain 5% to 60% by weight, more preferably 10% to 50% by weight and especially preferably 20% to 50% by weight of the one or more ammonium salts.

As component c), the adjuvant compositions comprise propylene glycol or dipropylene glycol, and combinations of the two with one another or with polypropylene glycol or polyethylene glycol having up to 10 repeat units. Preference is given to propylene glycol.

The propylene glycol content is preferably 1% to 30% by weight, more preferably 2% to 10% by weight and especially preferably 2% to 5% by weight.

As component d), the adjuvant compositions comprise water. Useful water includes, for example, demineralized water, groundwater, seawater or tap water. The water preferably has a hardness below 15° dH (German hardness).

The water content is preferably 20% to 89% by weight, more preferably 25% to 70% by weight and especially preferably 30% to 60% by weight.

In one embodiment, the adjuvant compositions may comprise, in addition to components a) to d), apart from component c), a further cosolvent e).

The cosolvent e) optionally present may either be present as a secondary component from the preparation process of the alkylglucamide or have been added subsequently to the adjuvant composition. The cosolvent may be a single solvent or a mixture of two or more solvents. Suitable solvents for this purpose are all polar solvents that are compatible with the aqueous pesticide composition and form a homogeneous phase. Suitable cosolvents are, for example, monohydric alcohols such as methanol, ethanol, propanols, butanols, benzyl alcohol or further polyhydric alcohols such as ethylene glycol, diethylene glycol or glycerol, or polyglycols such as polyethylene glycols, polypropylene glycols or mixed polyalkylene glycols (PAGs). Further suitable solvents are ethers, for example propylene glycol mono- or dimethyl ether, dipropylene glycol mono- or dimethyl ether, amides, for example N-methyl- or N-ethylpyrrolidone, N,N-dimethyllactamide, -caprylamide or -decanamide.

The proportion of the cosolvent in the composition, if present, is typically 10 to 250 g/L, preferably 20 to 200 g/L and more preferably 30 to 150 g/L.

In a preferred embodiment, the adjuvant of the invention does not contain any further cosolvent e).

In a further embodiment, the adjuvant compositions of the invention may comprise, as well as components a) to d) and optionally e), one or more further auxiliaries f), which may be, for example, preservatives, surfactants, defoamers, functional polymers or additional adjuvants. Examples of such auxiliaries can be found further down.

The adjuvant compositions are suitable as adjuvants in aqueous pesticide compositions for improving the biological activity of herbicides, insecticides, fungicides, acaricides, bactericides, molluscicides, nematicides and rodenticides.

The invention therefore also provides for the use of the adjuvant compositions of the invention for enhancing the biological activity of pesticides, especially of herbicides.

The adjuvant compositions are outstandingly suitable for production of storage-stable aqueous pesticide compositions having advantageous properties.

The invention therefore also provides for the use of adjuvant compositions of the invention for production of aqueous pesticide compositions. Processes for producing such pesticide compositions are known to those skilled in the art.

The invention also further provides aqueous pesticide compositions comprising
a) one or more alkylglucamides of the formula (I)

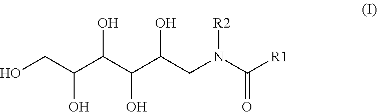

in which
R1 is a linear or branched alkyl group having 5 to 9 carbon atoms,
R2 is an alkyl group having 1 to 3 carbon atoms,
b) one or more ammonium salts,
c) propylene glycol, dipropylene glycol, mixtures of propylene glycol and dipropylene glycol, each optionally in a mixture with polypropylene glycol and/or polyethylene glycol, each having up to ten repeat units,
d) water,
e) optionally one or more cosolvents,
f) optionally one or more auxiliaries,
g) one or more water-soluble pesticides and
h) optionally one or more water-insoluble pesticides.

Water-soluble pesticides in the context of the invention are understood to mean pesticides having a solubility at room temperature (25° C.) of more than 50 g/L and preferably more than 100 g/L in water. Particular preference is given to pesticides having, at the use concentration at 20° C., a solubility of at least 90% by weight.

Preferred pesticides include fungicides, bactericides, insecticides, acaricides, nematicides, herbicides, plant growth regulators, plant nutrients and repellents.

The compositions of the invention are preferably suitable for combinations comprising one or more of the following water-soluble active ingredients (component g):

The compositions of the invention may additionally, in the formulation or else the spray liquor, comprise further pesticides which may be present in dissolved or else dispersed form.

Further examples of pesticides are mentioned hereinafter, which may be present in dissolved form as component (g) or as a combination partner for these pesticides (component h)).

Examples of herbicides include: acifluorfen, aminopyralid, amitrole, asulam, benazolin, bentazon, bialaphos, bicyclopyron, bispyribac, bromacil, bromoxynil, chloramben, clopyralid, 2,4-D, 2,4-DB, dicamba, dichlorprop, dichlorprop-P, difenzoquat, diquat, endothal, fenoxaprop, fenoxaprop-P, flamprop, florasulam, flumiclorac, fluoroglycofen, fluroxypyr, fomesafen, fosamine, glufosinate, glufosinate-P, glyphosate, imazameth, imazamethabenz, imazamox, imazapic, imazapyr, imazaquin, imazethapyr, MCPA, MCPB, mecoprop, mesotrione, nicosulfuron, octanoic acid, pelargonic acid, picloram, quizalofop, quizalofop-P, 2,3,6-TBA, sulcotrione, tembotrione and triclopyr, preferably each in the form of their water-soluble salts.

Preferred salts here are, for example, acifluorfen-sodium, bialafos-sodium, bispyridac-sodium, glufosinate-ammonium, glufosinate-P-ammonium, glufosinate-P-sodium, glyphosate-isopropylammonium, glyphosate-trimesium, imazamox-ammonium, imazapyr-isopropylammonium, imazaquinammonium, imazethapyr-ammonium, MCPB-sodium, mecocrop-sodium, mecocrop-P-dimethylammonium and mecocrop-P-potassium.

Active ingredients based on inhibition of, for example, acetolactate synthase, acetyl-CoA carboxylase, cellulose synthase, enolpyruvylshikimate-3-phosphate synthase, glutamine synthetase, p-hydroxyphenyl pyruvate dioxygenase, phytoendesaturase, photosystem I, photosystem II, protoporphyrinogen oxidase usable, as described, for example, from Weed Research 26 (1986) 441 445 or “The Pesticide Manual”, 16th edition, The British Crop Protection Council and the Royal Soc. of Chemistry, 2012 and literature cited therein. Known herbicides or plant growth regulators which can be combined with the compounds of the invention include, for example, the following active ingredients (the compounds are referred to either by the common name according to the International Organization for Standardization (ISO) or by the chemical name or by the code number) and always encompass all use forms such as acids, salts, esters and isomers such as stereoisomers and optical isomers. This list includes, by way of example, one use form and in some cases also a plurality of use forms:

acetochlor, acibenzolar, acibenzolar-S-methyl, aclonifen, alachlor, allidochlor, alloxydim, alloxydim-sodium, ametryn, amicarbazone, amidochlor, amidosulfuron, aminocyclopyrachlor, aminocyclopyrachlor-potassium, aminocyclopyrachlor-methyl, ammonium sulfamate, ancymidol, anilofos, atrazine, aviglycin, azafenidin, azimsulfuron, aziprotryn, beflubutamid, benazolinethyl, bencarbazone, benfluralin, benfuresate, bensulide, bensulfuron, bensulfuron-methyl, benzfendizone, benzobicyclon, benzofenap, benzofluor, benzoylprop, benzyladenin, bifenox, bilanafos, bilanafos-sodium, bromobutide, bromofenoxim, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat chloride, chlornitrofen, 4-chlorophenoxyacetic acid, chlorophthalim, chlorpropham, chlorthal-dimethyl, chlorotoluron, chlorsulfuron, cinidon, cinidonethyl, cinmethylin, cinosulfuron, clethodim, clodinafop, clodinafop-propargyl, clofencet, clomazone, clomeprop, cloprop, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, daimuron/dymron, dalapon, daminozide, dazomet, n-decanol, desmedipham, desmetryn, detosyl pyrazolate (DTP), diallate, diaminozid, dichlobenil, dichlorprop-P, diclofop, diclofop-methyl, diclofop-P-methyl, diclosulam, diethatyl, diethatyl-ethyl, difenoxuron, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, diisopropylnaphthalene, dipropetryn, diquat dibromide, dithiopyr, diuron, DNOC, eglinazine-ethyl, EPTC, esprocarb, ethalfluralin, ethametsulfuron, ethametsulfuron-methyl, ethylnaphthyl acetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop-ethyl, fenoxaprop-P-ethyl, fenoxasulfone, fentrazamide, fenuron, flamprop, flamprop-M-isopropyl, flamprop-M-methyl, flazasulfuron, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyrethyl, flumetralin, flumetsulam, flumiclorac-pentyl, flumioxazin, flumipropyn, fluometuron, fluorodifen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr-meptyl, flurprimidol, flurtamone, fluthiacet, fluthiacet-methyl, fluthiamide, foramsulfuron, forchlorfenuron, furyloxyfen, gibberellic acid, H-9201, i.e. O-(2,4 -dimethyl-6-nitrophenyl)-O-ethylisopropylphosphorus amidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz-methyl, imazosulfuron, inabenfide, indanofan, indaziflam, indoleacetic acid (IAA), 4-indol-3-ylbutyric acid (IBA), iodosulfuron, iodosulfuronmethyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, maleic hydrazide, MCPB-methyl, -ethyl, mecoprop-butotyl, mecoprop-P-butotyl, mecoprop-P-2-ethylhexyl, mefenacet, mefluidide, mepiquat chloride, mesosulfuron, mesosulfuron-methyl, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazin-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazol, paraquat, paraquat dichloride, pendimethalin, pendralin, penoxsulam, pentanochlor, pentoxazone, perfluidone, pethoxamid, phenisopham, phenmedipham, phenmedipham-ethyl, picolinafen, pinoxaden, piperophos, pirifenop, pirifenop-butyl, pretilachlor, primisulfuron, primisulfuron-methyl, probenazole, profluazol, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofopethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulfallate (CDEC), sulfentrazone, sulfometuron, sulfometuron-methyl, sulfo-sulfuron, SW-065, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tepraloxydim, terbacil, terbucarb, terbuchlor, terbumeton, terbuthylazine, terbutryn, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0862, i.e. 3,4-dichloro-N-{2-[(4,6-dimethoxypyrimidin-2-yl)oxy]benzyl}aniline, and the following compounds:

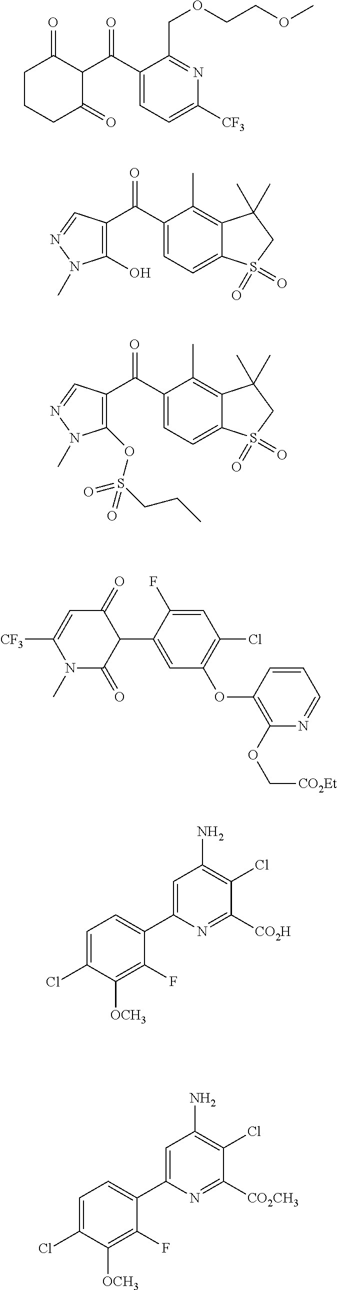 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(C2C(=O)C=C(C(F)(F)F)N(C)C2=O)c(F)cc1Cl ; COc1c(Cl)ccc(-c2cc(N)c(Cl)c(C(=O)O)n2)c1F ; COC(=O)c1nc(-c2ccc(Cl)c(OC)c2F)cc(N)c1Cl]

Examples of plant growth regulators further include natural plant hormones such as abscisic acid, jasmonic acid, salicylic acid and esters thereof, kinetin and brassinosteroids.

Further substances that should be mentioned are those which can act as plant growth regulators and/or plant fortifiers, in order to reduce the effect of stress factors such as heat, cold, drought, salt, oxygen deficiency or flooding on plant growth. Examples of these include glycine betaine (betaine), choline, potassium phosphate or other phosphate salts, and silicates.

Examples of plant nutrients include customary inorganic or organic fertilizers for supplying plants with macro- and/or micronutrients.

Examples of fungicides include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1-(4-methoxyphenoxy)-3,3-dimethylbutan-2-yl]1H-imidazole-1-carbothioate.
(2) Respiration inhibitors (respiratory chain inhibitors), for example bixafen, boscalid, carboxin, diflumetorim, fenfuram, fluopyram, flutolanil, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazoline-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.
(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.
(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.
(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.
(6) Resistance inductors, for example acibenzolar-S-methyl, isotianil, probenazole and tiadinil.
(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.
(8) Inhibitors of ATP production, for example fentin acetate, fentin chloride, fentin hydroxide and silthiofam.
(9) Cell wall synthesis inhibitors, for example benthiavalicarb, dimethomorph, flumorph, iprovalicarb, mandipropamid, polyoxins, polyoxorim, validamycin A and valifenalate.
(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.
(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoyl)amino]butan-2-yl}carbamate.
(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.
(13) Signal transduction inhibitors, for example chlozolinate, fenpiclonil, fludioxonil, iprodione, procymidone, quinoxyfen and vinclozolin.
(14) Decouplers, for example binapacryl, dinocap, ferimzone, fluazinam and meptyldinocap.
(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7(2H,6H)-tetrone, 2-[5-methyl-3-(trifluoromethyl)-1H-pyrazol-1-yl]-1-(4-{4-[(5R)-5-phenyl-4, 5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4, 5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]pyrimidine-4-amine, 5-fluoro-2-[(4-methylbenzyl)oxy]pyrimidine-4-amine, 5-methyl-6-octyl[1,2,4]triazolo[1,5-a]pyrimidine-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)methyl]pyridin-2-yl}carbamate.
(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone, N-[2-(4-{[3-(4-chlorophenyl)prop-2-yn-1-yl]oxy}-3-methoxyphenyl)ethyl]-N2-(methylsulfonyl)valinamide, 4-oxo-4-[(2-phenylethyl)amino]butanoic acid and but-3-yn-1-yl {6-[({[(Z)-(1-methyl-1H-tetrazol-5-yl)(phenyl)methylene]amino}oxy)methyl]pyridin-2-yl}carbamate.

All fungicides (1) to (16) mentioned may, when they are capable on account of their functional groups, optionally form salts with suitable bases or acids.

Examples of bactericides include:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Examples of insecticides, acaricides and nematicides include:

(1) Acetylcholinesterase (AChE) inhibitors, for example
carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
organophosphates, e.g. acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

GABA-gated chloride channel antagonists, for example

cyclodiene organochlorines, e.g. chlordane and endosulfan; or phenylpyrazoles (fiproles), e.g. ethiprole and fipronil.
(3) Sodium channel modulators/voltage-gated sodium channel blockers, for example
pyrethroids, e.g. acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans isomer], prallethrin, pyrethrins (pyrethrum), resmethrin, silafluofen, tefluthrin, tetramethrin, tetramethrin [(1R) isomers)], tralomethrin and transfluthrin; or
DDT; or methoxychlor.
(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam; or nicotine.
(5) Allosteric activators of the nicotinergic acetylcholine receptor (nAChR), for example
spinosyns, e.g. spinetoram and spinosad.
(6) Chloride channel activators, for example
avermectins/milbemycins, e.g. abamectin, emamectin benzoate, lepimectin and milbemectin.
(7) Juvenile hormone imitators, for example
juvenile hormone analogs, e.g. hydroprene, kinoprene and methoprene; or fenoxycarb; or pyriproxyfen.
(8) Active ingredients with unknown or nonspecific mechanisms of action, for example
alkyl halides, e.g. methyl bromide and other alkyl halides; or chloropicrin; or sulfuryl fluoride; or borax; or tartar emetic.
(9) Selective antifeedants, e.g. pymetrozine; or flonicamid.
(10) Mite growth inhibitors, e.g. clofentezine, hexythiazox and diflovidazin; or etoxazole.
(11) Microbial disruptors of the insect gut membrane, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.
(12) Oxidative phosphorylation inhibitors, ATP disruptors, for example diafenthiuron; or
organotin compounds, e.g. azocyclotin, cyhexatin and fenbutatin oxide; or propargite; or tetradifon.
(13) Oxidative phosphorylation decouplers that interrupt the H proton gradient, for example chlorfenapyr, DNOC and sulfluramid.
(14) Nicotinergic acetylcholine receptor antagonists, for example bensultap, cartap hydrochloride, thiocyclam, and thiosultap-sodium.
(15) Chitin biosynthesis inhibitors, type 0, for example bistrifluron, chlorfluazuron, diflubenzuron, flucycloxuron, flufenoxuron, hexaflumuron, lufenuron, novaluron, noviflumuron, teflubenzuron and triflumuron.
(16) Chitin biosynthesis inhibitors, type 1, for example buprofezin.
(17) Moulting disruptors, dipteran, for example cyromazine.
(18) Ecdysone receptor agonists, for example chromafenozide, halofenozide, methoxyfenozide and tebufenozide.
(19) Octopaminergic agonists, for example amitraz.
(20) Complex-III electron transport inhibitors, for example hydramethylnon; or acequinocyl; or fluacrypyrim.
(21) Complex-I electron transport inhibitors, for example
METI acaricides, e.g. fenazaquin, fenpyroximate, pyrimidifen, pyridaben, tebufenpyrad and tolfenpyrad; or rotenone (Derris).
(22) Voltage-gated sodium channel blockers, for example indoxacarb; or metaflumizone.
(23) Inhibitors of acetyl-CoA carboxylase, for example
tetronic and tetramic acid derivatives, e.g. spirodiclofen, spiromesifen and spirotetramat.
(24) Complex-IV electron transport inhibitors, for example
phosphines, e.g. aluminum phosphide, calcium phosphide, phosphine and zinc phosphide; or
cyanide.
(25) Complex-II electron transport inhibitors, for example cyenopyrafen.
(28) Ryanodine receptor effectors, for example
diamides, e.g. chlorantraniliprole and flubendiamide.

Further active ingredients with an unknown mechanism of action, for example amidoflumet, azadirachtin, benclothiaz, benzoximate, bifenazate, bromopropylate, chinomethionat, cryolite, cyantraniliprole (Cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and additionally preparations based on Bacillus firmus (I-1582, BioNeem, Votivo) and the following active compounds:

3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934), 4-{[(6-bromopyrid-3-yl)methyl](2-fluoroethyl)amino}furan-2(5H)-one (known from WO2007/115644), 4-{[(6-fluoropyrid-3-yl)methyl](2,2-difluoroethyl)amino}furan-2(5H)-one (known from WO2007/115644), 4-{[(2-chloro-1,3-thiazol-5-yl)methyl](2-fluoroethyl)amino}furan-2(5H)-one (known from WO2007/115644), 4-{[(6-chloropyrid-3-yl)methyl](2-fluoroethyl)amino}furan-2(5H)-one (known from WO2007/115644), 4-{[(6-chloropyrid-3-yl)methyl](2,2-difluoroethyl)amino}furan-2(5H)-one (known from WO2007/115644), 4-{[(6-chloro-5-fluoropyrid-3-yl)methyl](methyl)amino}furan-2(5H)-one (known from WO2007/115643), 4-{[(5,6-dichloropyrid-3-yl)methyl](2-fluoroethyl)amino}furan-2(5H)-one (known from WO2007/115646), 4-{[(6-chloro-5-fluoropyrid-3-yl)methyl](cyclopropyl)amino}furan-2(5H)-one (known from WO2007/115643), 4-{[(6-chloropyrid-3-yl)methyl](cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), {[1-(6-chloropyridin-3-yl)ethyl](methyl)oxido-λ4-sulfanylidene}cyanamide (known from WO2007/149134) and its diastereomers {[(1R)-1-(6-chloropyridin-3-yl)ethyl](methyl)oxido-λ4-sulfanylidene}cyanamide (A) and {[(1 S)-1-(6-chloropyridin-3-yl)ethyl](methyl)oxido-λ4-sulfanylidene}cyanamide (B) (likewise known from WO2007/149134), and also sulfoxaflor (likewise known from WO2007/149134) and its diastereomers [(R)-methyl(oxido){(1R)-1-[6-(trifluoromethyl)pyridin-3-yl]ethyl}-λ4-sulfanylidene]cyanamide (A1) and [(S)-methyl(oxido){(1S)-1-[6-(trifluoromethyl)pyridin-3-yl]ethyl}-λ4-sulfanylidene]cyanamide (A2), referred to as diastereomer group A (known from WO 2010/074747, WO 2010/074751), [(R)-methyl(oxido){(1S)-1-[6-(trifluoromethyl)pyridin-3-yl]ethyl}-λ4-sulfanylidene]cyanamide (B1) and [(S)-methyl(oxido){(1R)-1-[6-(trifluoromethyl)pyridin-3-yl]ethyl}-λ4-sulfanylidene]cyanamide (B2), referred to as diastereomer group B (likewise known from WO 2010/074747, WO 2010/074751) and 11-(4-chloro-2,6-dimethylphenyl)-12-hydroxy-1,4-dioxa-9-azadispiro[4.2.4.2]tetradec-11-en-10-one (known from WO2006/089633), 3-(4′-fluoro-2,4-dimethylbiphenyl-3-yl)-4-hydroxy-8-oxa-1-azaspiro[4.5]dec-3-en-2-one (known from WO2008/067911), 1-{2-fluoro-4-methyl-5-[(2,2,2-trifluoroethyl)sulfinyl]phenyl}-3-(trifluoromethyl)-1H-1,2,4-triazol-5-amine (known from WO2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO2008/066153), 2-cyano-3-(difluoromethoxy)-N,N-dimethylbenzenesulfonamide (known from WO2006/056433), 2-cyano-3-(difluoromethoxy)-N-methylbenzenesulfonamide (known from WO2006/100288), 2-cyano-3-(difluoromethoxy)-N-ethylbenzenesulfonamide (known from WO2005/035486), 4-(difluoromethoxy)-N-ethyl-N-methyl-1,2-benzothiazol-3-amine 1,1-dioxide (known from WO2007/057407), N-[1-(2,3-dimethylphenyl)-2-(3,5-dimethylphenyl)ethyl]-4,5-dihydro-1,3-thiazol-2-amine (known from WO2008/104503), {I-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), (2,2,3,3,4,4,5,5-octafluoropentyl)(3,3,3-trifluoropropyl)malononitrile (known from WO2005/063094), (2,2,3,3,4,4,5,5-octafluoropentyl)(3,3,4,4,4-pentafluorobutyl)malononitrile (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (known from WO2007/040280), 2-ethyl-7-methoxy-3-methyl-6-[(2,2,3,3-tetrafluoro-2,3-dihydro-1,4-benzodioxin-6-yl)oxy]quinolin-4-yl methyl carbonate (known from JP2008/110953), 2-ethyl-7-methoxy-3-methyl-6-[(2,2,3,3-tetrafluoro-2,3-dihydro-1,4-benzodioxin-6-yl)oxy]quinolin-4-yl acetate (known from JP2008/110953), PF1364 (CAS reg. no. 1204776-60-2) (known from JP2010/018586), 5-[5-(3,5-dichlorophenyl)-5-(trifluoromethyl)-4,5-dihydro-1,2-oxazol-3-yl]-2-(1H-1,2,4-triazol-1-yl)benzonitrile (known from WO2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (known from WO2005/085216), 4-{[(6-chloropyridin-3-yl)methyl](cyclopropyl)amino}-1,3-oxazol-2(5H)-one, 4-{[(6-chloropyridin-3-yl)methyl]-(2,2-difluoroethyl)amino}-1,3-oxazol-2(5H)-one, 4-{[(6-chloropyridin-3-yl)methyl](ethyl)amino}-1,3-oxazol-2(5H)-one, 4-{[(6-chloropyridin-3-yl)methyl](methyl)amino}-1,3-oxazol-2(5H)-one (all known from WO2010/005692), NNI-0711 (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (known from WO2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), (5RS,7RS; 5RS,7SR)-1-(6-chloro-3-pyridylmethyl)-1,2,3,5,6,7-hexahydro-7-methyl-8-nitro-5-propoxyimidazo[1,2-a]pyridine (known from WO2007/101369), 2-{6-[2-(5-fluoropyridin-3-yl)-1,3-thiazol-5-yl]pyridin-2-yl}pyrimidine (known from WO2010/006713), 2-{6-[2-(pyridin-3-yl)-1,3-thiazol-5-yl]pyridin-2-yl}pyrimidine (known from WO2010/006713), 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide (known from WO2010/069502), 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide (known from WO2010/069502), N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide (known from WO2010/069502), N-[2-(tert-butylcarbamoyl)-4-cyano-6-methylphenyl]-1-(3-chloropyridin-2-yl)-3-{[5-(trifluoromethyl)-2H-tetrazol-2-yl]methyl}-1H-pyrazole-5-carboxamide (known from WO2010/069502) and (1E)-N-[(6-chloropyridin-3-yl)methyl]-N′-cyano-N-(2,2-difluoroethyl)ethanimidamide (known from WO2008/009360).

The active ingredients referred to here by their common names are known and are described, for example, in the Pesticide Manual (16th ed., British Crop Protection Council 2012) or can be searched for on the Internet (e.g. http://www.alanwood.net/pesticides).

The pesticides of component g) may also be a combination of two or more pesticides. Such combinations are of significance especially when the aim is, for example, to broaden the spectrum of action of the pesticide composition or to better suppress resistances to particular pesticides.

The combination of two or more pesticides in one formulation is a difficult undertaking. The active ingredients are typically incompatible with one another and the aqueous mixtures are therefore not phase-stable. However, the adjuvant compositions of the invention are of good suitability for stabilization of such basically incompatible compositions.

In a further embodiment of the invention, the pesticide compositions of the invention therefore comprise at least two water-soluble pesticides of component g).

The aim in the formulation of aqueous pesticide compositions is to load the composition with a maximum concentration of active ingredient. This reduces packaging, transport, storage and disposal costs. Therefore, an adjuvant composition should be capable of enabling stable high-load pesticide compositions, called “high-load formulations”. This is possible in a surprisingly efficient manner with the alkylglucamides of the formula (I).

In a preferred embodiment of the invention, the amount of the one or more water-soluble pesticide(s) of component g) in the compositions of the invention is more than 100 g/L, preferably more than 200 g/L and more preferably more than 300 g/L. These figures are based on the total weight of the pesticide composition of the invention and, in the case of pesticides which are used in the form of their water-soluble salts (such as typically glyphosate or 2,4-D, for example), on the amount of free acid, called the acid equivalent (a.e.).

In a further preferred embodiment of the invention, the amount of the one or more alkylglucamides of the formula (I) in the pesticide compositions of the invention is 20 to 250 g/L, preferably 40 to 200 g/L and more preferably 50 to 150 g/L. These figures are based on the total amount of the pesticide composition of the invention.

Typically, the alkylglucamides of the formula (I) are used in the form of solutions. For clarification, it should be mentioned here that the figures given above are based on the active content of the alkylglucamides of the formula (I) in the solution.

A particularly important criterion for the storage stability of aqueous pesticide compositions, for example glyphosate and 2,4-D formulations, is phase stability. A composition is regarded as having sufficient phase stability when it remains homogeneous over a wide temperature range and when there is no formation of two or more separate phases or precipitates (formation of a further solid phase). Phase stability is the crucial prerequisite for a storage-stable formulation both at elevated temperature, as can occur, for example, in the case of storage in the sun or in warm countries, and at low temperature, for example in winter or in cold climatic regions.

It is a feature of the pesticide compositions of the invention that they are phase-stable even at a temperature of preferably greater than 55° C., more preferably of greater than 70° C. and especially preferably of greater than 80° C.

It is also a feature of the pesticide compositions of the invention that they are phase-stable even at a temperature of preferably less than 10° C., more preferably of less than 0° C. and especially preferably of less than −10° C.

The pH of the pesticide compositions is typically within the range from 3.5 to 8.5, preferably 4.0 to 8.0 and more preferably 4.5 to 6.5 (measured as a 1% by weight aqueous dilution). The pH is determined primarily by the pH values of the solutions of the aqueous pesticides, which take the form of salts of weak acids. By adding acids or bases, it is possible to adjust the pH to another value different than the original pH of the mixture.

The pesticide compositions of the invention may comprise, as well as components a) to d), g) and optionally h), one or more further auxiliaries f), which may be, for example, preservatives, surfactants, defoamers, functional polymers or additional adjuvants.

Preservatives used may be organic acids and esters thereof, for example ascorbic acid, ascorbyl palmitate, sorbate, benzoic acid, methyl and propyl 4-hydroxybenzoate, phenol, for example 2-phenylphenate, 1,2-benzisothiazolin-3-one, formaldehyde, sulfurous acid and salts thereof.

The surfactants may generally be any nonionic, amphoteric, cationic or anionic surfactants that are compatible with the composition.

Examples of nonionic surfactants are ethoxylates and alkoxylates of relatively long-chain aliphatic or aromatic alcohols, fatty amine ethoxylates, relatively long-chain etheramine alkoxylates, (optionally ethoxylated) sorbitan esters, alkyl polyglycosides. Suitable amphoteric surfactants include long-chain alkyl dimethylbetaines or alkyldimethylamine oxides, or alkyldimethylamine amidopropylamine oxides. Among the anionic surfactants, for example, ether sulfates of ethoxylated fatty alcohols, reaction products of (optionally ethoxylated) long-chain alcohols with phosphoric acid derivatives are suitable. “Long-chain” is understood to mean linear or branched hydrocarbon chains having at least 6 and at most 22 carbon atoms.

Suitable defoamers are fatty acid alkyl ester alkoxylates, organopolysiloxanes such as polydimethylsiloxanes and mixtures thereof with microfine, optionally silanized silica; perfluoroalkylphosphonates and -phosphinates, paraffins, waxes and microcrystalline waxes, and mixtures thereof with silanized silica. Also advantageous are mixtures of various foam inhibitors, for example those of silicone oil, paraffin oil and/or waxes.

The functional polymers which may be present in the pesticide composition of the invention are high molecular weight compounds of synthetic or natural origin having a molar mass of greater than 10 000. The functional polymers may act, for example, as anti-drift agents or increase rain resistance.

In a further preferred embodiment of the invention, the pesticide compositions of the invention comprise, as well as components a) to g), one or more further adjuvants as usable in a known manner in aqueous pesticide compositions.

These are preferably fatty amine ethoxylates, etheramine ethoxylates, alkyl betaines or amidoalkyl betaines, amine oxides or amidoalkylamine oxides, alkyl polyglycosides or copolymers of glycerol, coconut fatty acid and phthalic acid.

These adjuvants are known from the literature as adjuvants in aqueous pesticide compositions and are described, for example, in WO2009/029561.

In a further preferred embodiment of the invention, the pesticide compositions of the invention are in the form of concentrate formulations which are diluted prior to use, especially with water (for example “ready-to-use”, “in-can” or “built-in” formulations), and contain the one or more water-soluble pesticides of component d) generally in amounts of 5% to 80% by weight, preferably of 10% to 70% by weight and more preferably of 20% to 60% by weight, the one or more alkylglucamides of the formula (I) in amounts of 1% to 25% by weight, preferably of 2% to 20% by weight and more preferably of 3% to 15% by weight, the ammonium salt b) in amounts of 5% to 50% by weight, preferably 10% to 40% by weight and more preferably 10% to 35% by weight, and propylene glycol c) in amounts of 1% to 30% by weight, preferably of 2% to 10% by weight and more preferably of 2% to 5% by weight. These figures are based on the overall concentrate formulation and, in the case of pesticides which are used in the form of their water-soluble salts, on the amount of free acid, called the acid equivalent (a.e.).

The pesticide compositions of the invention are preferably deployed to the fields in the form of spray liquors. The spray liquors are produced by diluting concentrate formulations with a defined amount of water.

In a further preferred embodiment of the invention, the pesticide compositions of the invention are in the form of spray liquors and contain 0.001% to 10% by weight, preferably 0.02% to 3% by weight and more preferably 0.025% to 2% by weight of the one or more water-soluble pesticides of component g) and 0.001% to 3% by weight, preferably 0.005% to 1% by weight and more preferably 0.01% to 0.5% by weight of the one or more alkylglucamides of the formula (I). The amount of the ammonium salts used in accordance with the invention is generally 0.05% to 2.00%, preferably 0.10% to 1.50% and more preferably 0.20% to 1.00%, based on the spray liquor. The content of the glycol compounds of component c) is generally not more than 0.20% by weight, based on the spray liquor. The figures given are based on the overall spray liquor and, in the case of pesticides which are used in the form of their water-soluble salts, on the amount of free acid, called the acid equivalent (a.e.).

The invention further relates to the use of the pesticide compositions of the invention for control and/or for abatement of weeds, fungal diseases or insect infestation. Preference is given to the use of the compositions of the invention for control and/or for abatement of weeds.

These uses can preferably also take place in what is known as the tankmix method. In this case, the one or more water-soluble pesticides of component g) and components a) to d) and additionally water may thus also take the form of a “tankmix” preparation. In such a preparation, both the one or more water-soluble pesticides(s) and components a) to d), the latter optionally together with further adjuvants, are present separately from one another. The two preparations are mixed with one another prior to deployment, generally shortly beforehand, giving rise to a pesticide composition of the invention.

### WORKING EXAMPLES

### Production

The use concentrations in the test are always based on the tested product and, with regard to the linear C8/10 glucamide itself, what is always meant is a stable solution with 50% active substance content in water/propylene glycol.

The solution with 50% active C8/10 glucamide substance was produced as follows: First of all, according to EP 0 550 637, C8/10 fatty acid methyl ester (methyl octanoate:methyl decanoate=55:45) is reacted with N-methylglucamine in the presence of 1,2-propylene glycol as solvent and obtained as a solid consisting of 90% active substance and 10% 1,2-propylene glycol. This solid was dissolved at 40 to 50° C. in water, so as to give a solution with a 50% content of linear C8/10 glucamide. This is a clear colorless solution.

Increasing the absorption of systemic active ingredients or herbicides and test systems for measurement of the promotion of penetration of active ingredients

Surfactants can also promote the absorption of (active) ingredients through membranes such as skin, films or the plant cuticle. As a “finite-dose” application, it is known for the single administration or application of a solution, cream, gel etc. to a membrane that the absorption of active ingredient can be influenced by some additives such as surfactants even after wetting. This effect is independent of the interfacial effect in water, is often highly concentration-dependent and takes place for the most part after evaporation of water and any solvents present as a result of the interaction, for example, with active ingredient, membrane and environmental factors. For various surfactants, it is observed after addition to active ingredient preparations that the penetration of a particular active ingredient is promoted to an enormous degree by some surfactants, whereas others are entirely ineffective (Cronfeld, P, Lader, K. Baur, P. (2001). Classification of Adjuvants and Adjuvant Blends by Effects on Cuticular Penetration, Pesticide Formulations and Application Systems: Twentieth Volume, ASTM STP 1400, A. K. Viets, R. S. Tann, J. C. Mueninghoff, eds., American Society for Testing and Materials, West Conshohocken, Pa. 2001).

The potential of the C8/10 glucamide, which is independent of the surfactant action, to promote foliar absorption of active agrochemical ingredients was determined in membrane penetration tests with apple or pear leaf cuticles. The plant cuticle is a lipophilic solubility membrane (lipid membrane) without pores or holes, and the results described are also expected for other nonporous lipophilic solubility membranes with these or other electrolyte active ingredients. The principle of the method has been published (e.g. WO-A-2005/194844; Baur, 1997; Baur, Grayson and Schönherr 1999; Baur, Bodelon and Lowe, 2012), and only the specifics and differences in the method are elucidated hereinafter. The leaf cuticles were enzymatically isolated in the manner described in the literature from apple leaves of orchard trees in a commercial fruit growing facility near Frankfurt am Main in 2011. The stomata-free cuticles were first dried under air and then installed into stainless steel diffusion cells. After application to the original upper side of the leaf and evaporation of the test liquid, i.e. of the aqueous preparations of the active ingredients without or with the C8/10-glucamide-containing spray liquids or comparative compositions, the diffusion cells were transferred into thermostatted blocks and charged with aqueous liquid. The water used to make up the aqueous test liquids was local tap water (of known composition). At regular intervals, samples were taken and, irrespective of the test system, the proportion of active ingredient penetrated was determined either by HPLC or scintillation measurement. In the system containing radiolabeled active ingredients (dicamba, 2,4-D, MCPA), the aqueous liquid was a phospholipid suspension and the total amount was exchanged. In all other HPLC variants, only an aliquot was taken. During the experiment, the temperature in the system (block, diffusion cells, liquids, etc.) and the air humidity above the spray coating on the cuticle were known exactly and were monitored. In the experiments, the relative air humidity was kept constant throughout at 56% relative air humidity (air over supersaturated calcium nitrate) or 60% relative air humidity (dew point method); the temperature was either constant throughout at 25° C. or RT 22(±1°) C. or the temperature was raised by 10° C. after 24 h hours. The analytical determination was effected either by means of HPLC (1290 Infinity, Agilent) or analysis of radioactivity (Tricarb, Perkin Elmer). HPLC separation was with a Kinetex column 30×2.1 mm, 2.6 μC18 100A (Phenomenex), taking 20 μL aliquots as the injection volume at the specified times. In the tests with radiolabeled substances, the sample volume was 0.5 mL and the measurement was effected via scintillation (Baur, Grayson and Schönherr 1999). In each case, the geometric mean values of the penetration for intact membranes at the mean measurement times are given. According to the variant (active ingredient×test additive/formulation), 7-8 repetitions were set up. The coefficient of variation was usually below 35%, but in individual cases may be up to 50%, which is a typical biological variability for penetration for numerous plants (Baur, 1997).

By way of example, the following adjuvant formulations (F) were tested with a widely differing ratio of C8/10 glucamide and ammonium sulfate. The spray liquid was local tap water with 85 ppm of Ca and 16 ppm of Mg, levels which are of relevance and potentially antagonistic for herbicide electrolytes. This tap water was in some cases enriched with calcium, such that a concentration of 177 ppm of Ca was attained, which corresponds to very hard water. The penetration test is of very good suitability for measuring the antagonism of Ca for the penetration of acids (see Uhlig, Baur and Schönherr 1998). This effect was measured with the formulations comprising ammonium sulfate. The same effects are expected with ammonium citrate and oxalate, and other anions that form sparingly soluble calcium salts. Much less significant but likewise relevant are antagonism by iron or magnesium, which can likewise be neutralized with the formulations F1-7. In the case of softer water (75 ppm of Ca), an enhancement of effect can also be achieved with other ammonium salts such as nitrate, chloride etc., or else with ammonium nitrate-urea combinations.

### Formulations

F1 45% by weight of linear C8/10 glucamide, 5% by weight of propylene glycol and 20% by weight of ammonium sulfate, remainder water
F2 10% by weight of linear C8/10 glucamide, 25% by weight of ammonium sulfate, 10% by weight of fructose-glucose syrup (55% by weight of fructose, 42% by weight of glucose), 3% by weight of propylene glycol, 0.03% by weight of defoamer (Momentive SAG 1572 SGS), remainder water
F3 10% by weight of linear C8/10 glucamide, 25% by weight of ammonium sulfate, 10% by weight of polyglycerol (with 7-10 glycerol monomers), 3% by weight of propylene glycol, 0.03% by weight of defoamer (Momentive SAG 1572 SGS), remainder water
F4 5% by weight of linear C8/10 glucamide, 35% by weight of ammonium sulfate, 10% by weight of fructose-glucose syrup (55% by weight of fructose, 42% by weight of glucose), 2.5% by weight of propylene glycol, 0.03% by weight of defoamer (Momentive SAG 1572 SGS), remainder water
F5 15% by weight of linear C8/10 glucamide, 20% by weight of ammonium sulfate, 2% by weight of propylene glycol, 0.03% by weight of defoamer (Momentive SAG 1572 SGS), remainder water
F6 is a 2.5:1 mixture of F1 and Synergen GL8 (an alkyl(hydroxyethyl)dimethylammonium chloride, Clariant)
F7 is a 3:2 mixture of F1 and Synergen GL8 (an alkyl(hydroxyethyl)dimethylammonium chloride, Clariant)
F8 is a mixture of the linear C8/10 glucamide in 25% by weight of AHL (ammonium nitrate-urea solution, Piasan 28) with 3 g/L linear C8/10 glucamide

The formulations F1-8 correspond to water-containing water-miscible SL formulations which are stable in any relationship. The glucamide itself and the concentrations set do not necessitate any biocide; the formulations go completely back into solution when thawed after storage at −20° C. and precipitation of ammonium sulfate. Standard storage tests (about 8 weeks at 40° C. or 2 weeks at 54° C.) do not alter the properties. The formulations can be diluted without any problem with all water qualities (CIPAC A,C,D, tap water, demineralized water).

### Effect Examples for Active Ingredients

### Test Substances for Penetration:

MCPA, iodosulfuron, 2,4-D (DMA), sulcotrione, mesotrione, clethodim,
dicamba (acid and DGA), saflufenacil, tembotrione

Effect examples for the increase in penetration with linear C8/10 glucamide compared to the active ingredient or an active ingredient-containing formulation alone and/or other comparators. The standard spray liquid was tap water with 85 ppm of Ca and 16 ppm of Mg. In each case, the agent alone and with addition of the test substance is shown.

The examples which follow with important active herbicidal ingredients each show the excellent suitability of the formulations comprising linear C8/10 glucamide with ammonium sulfate for promoting the penetration of a wide variety of different electrolyte active ingredients (herbicides here). The can lead to significantly better weed control, quicker rain resistance and better exploitation of the potential of active ingredients and, in individual cases, also to saving of active ingredient.

TABLE 1
Penetration of MCPA (potassium salt), (active
ingredient concentration 1 g/L in spray liquid)

| | Test product (conc.) | |
|---|---|---|
| | Mean penetration* in % after time (n = 4-8) | |
| | Spray liquor concentration | |
| | 1.0 g/L ai | |
| | 4 h | 1 day |
| MCPA potassium alone | 1.6 | 7.2 |
| F1 0.5% (inventive) | 11.3 | 31.6 |
| F2 0.5% (inventive) | 9.2 | 31.1 |
| F3 0.5% (inventive) | 9.6 | 32.3 |

*25° C./56% rel. air humidity

The inventive formulations F1-3 lead to a 4- to 7-fold increase in the penetration of MCPA-potassium after 4 hours or one day.

TABLE 2
Penetration of 2,4-D DMA** with antagonistic calcium at
177 ppm Ca, simulating very hard water (active ingredient
concentration 5 g/L of 2,4-D DMA in spray liquid)

| | Test product (conc.) | |
|---|---|---|
| | Mean penetration* in % after time (n = 4-8) | |
| | Spray liquor concentration | |
| | 5 g/L ai | |
| | 4 h | 1 day |
| 2,4-D DMA alone | 0.2 | 0.3 |
| F2 0.5% (inventive) | 15.4 | 14.4 |
| F4 0.5% (inventive) | 21.4 | 48.4 |
| F5 0.5% (inventive) | 4.8 | 15.0 |
| F6 0.35% (inventive) | 22.0 | 50.0 |

*25° C./56% rel. air humidity
**DMA, dimethylamine

The inventive formulations F2-6 lead to a more than 10-fold increase in the penetration of 2,4-D DMA after 4 hours or one day. F6 shows a better effect at a lower use concentration. This shows a synergistic effect, since Synergen GL8 (30% in F6) itself does not show any effect on the penetration.

TABLE 3
Penetration of dicamba (acid) with tap water
containing 85 ppm Ca (active ingredient concentration
1.0 g/L of 2,4-D DMA in spray liquid)

| | Test product (conc.) | |
|---|---|---|
| | Mean penetration* in % after time (n = 4-8) | |
| | Spray liquor concentration | |
| | 1.0 g/L ai | |
| | 5 h | 1 day |
| Dicamba (acid) alone, in | 4.4 | 12.4 |
| normal tap water (85 ppm) | | |
| F1 0.2% (inventive) | 20.0 | 42.5 |
| Genamin 267 | 7.0 | 26.2 |
| (commercial tallowamine | | |
| ethoxylate with 15 EO) | | |

*20° C./60% rel. air humidity

The inventive formulation F1 leads to a 3-4.5-fold increase in the penetration of dicamba acid after 5 hours or one day. This is quicker and more than with a tallowamine ethoxylate which is customary in the art. Since dicamba has significant volatility, the improved absorption can also suppress a reduction in the volatility and the deposition in non-targeted areas.

TABLE 4
Penetration of dicamba DGA** with antagonistic calcium at
177 ppm Ca, simulating very hard water (active ingredient
concentration 2.5 g/L of dicamba DGA in spray liquid)

| | Test product (conc.) | |
|---|---|---|
| | Mean penetration* in % after time (n = 4-8) | |
| | Spray liquor concentration | |
| | 2.5 g/L ai | |
| | 3 h | 1 day |
| Dicamba DGA SL500** | 0.9 | 14.3 |
| alone, in normal tap | | |
| water (85 ppm) | | |
| Dicamba DGA SL500** | 0.2 | 3.8 |
| alone, in tap water | | |
| (177 ppm) | | |
| F1 0.5% (inventive) | 9.7 | 28.9 |
| F2 0.5% (inventive) | 8.4 | 34.3 |
| F2 0.75% (inventive) | 8.9 | 39.8 |
| F3 0.5% (inventive) | 6.7 | 34.4 |
| F4 0.5% (inventive) | 3.3 | 39.7 |
| Premium Oil Concentrate | 0.3 | 4.6 |
| 0.5% (commercial) | | |

*20° C./60% rel. air humidity
**DGA, diglycolamine, from a soluble liquid formulation of the commercial products Clarity ® (BASF) or Sterling ® Blue (Winfield)

All formulations containing the linear C8/10 glucamide significantly increased the penetration. The higher the concentration of linear C8/10 glucamide, the more quickly the promotion of penetration occurred (F1>F2˜F3>F4). The crop oil concentrate had no effect at all in the case of the hard water, in spite of the additive content being twice as high.

TABLE 5
Penetration of sulcotrione (active ingredient
concentration 0.2 g/L in spray liquid)

| | Test product (conc.) | |
|---|---|---|
| | Mean penetration* in % after time (n = 4-8) | |
| | Spray liquor concentration | |
| | 0.2 g/L ai | |
| | 5 h | 1 day |
| Sulcotrione alone | <1 | <1 |
| F1 0.25% (inventive) | 1.8 | 8.7 |
| F1 0.5% (inventive) | 3.5 | 19.5 |

*20° C./60% rel. air humidity

The inventive formulation F1 leads to a concentration-dependent increase of more than 8-fold in the penetration of sulcotrione after 5 hours or one day.

TABLE 6
Penetration of mesotrione (active ingredient
concentration 0.3 g/L in spray liquid)

| | Test product (conc.) | |
|---|---|---|
| | Mean penetration* in % after time (n = 4-8) | |
| | Spray liquor concentration | |
| | 0.3 g/L ai | |
| | 1 day* | 2 days* |
| SC480 (Clariant) | <1 | <1 |
| F1 0.25% (inventive) | 12.9 | 22.9 |
| F1 0.5% (inventive) | 11.4 | 19.8 |

*25° C./60% rel. air humidity,
**increase after 1 day to 35° C./60% rel. air humidity

The inventive formulation F1 leads to a concentration-dependent increase of more than 10-fold in the penetration of mesotrione after 1 day or 2 days.

TABLE 7
Penetration of mesotrione (active ingredient
concentration 0.3 g/L in spray liquid)

| | Test product (conc.) | |
|---|---|---|
| | Mean penetration in % after time (n = 4-8) | |
| | Spray liquor concentration | |
| | 0.3 g/L ai | |
| | 1 day* | 2 days** |
| SC480 (Clariant) | 1.9 | 3.0 |
| F1 0.3% (inventive) | 3.8 | 12.8 |
| F2 0.5% (inventive) | 2.6 | 7.9 |
| F2 1.0% (inventive) | 16.4 | 33.9 |
| F3 0.75% (inventive) | 11.1 | 23.3 |
| F4 0.5% (inventive) | 17.0 | 17.1 |
| F7 0.5% (inventive) | 21.5 | 33.6 |

*25° C./60% rel. air humidity,
**increase after 1 day to 35° C./60% rel. air humidity

All inventive formulations tested were effective with a very significantly concentration-dependent rise in the penetration of mesotrione in the case of F2 and a very good result for F1 even at 0.3%.

TABLE 8
Penetration of clethodim (active ingredient
concentration 0.75 g/L in spray liquid)

| | Test product (conc.) | |
|---|---|---|
| | Mean penetration* in % after time (n = 4-8) | |
| | Spray liquor concentration | |
| | 0.75 g/L ai | |
| | 12 h | 1 day |
| Status ® EC240 | 3.5 | 4.8 |
| (commercial) | | |
| F1 0.5% (inventive) | 14.1 | 15.8 |

*25° C./56% rel. air humidity

The inventive formulation F1 leads to a 3- to 4-fold increase in the penetration of clethodim after 12 hours or 1 day.

TABLE 9
Penetration of saflufenacil** (active ingredient
concentration 0.5 g/L in spray liquid)

| | Test product (conc.) | | |
|---|---|---|---|
| | Mean penetration* in % after time (n = 4-8) | | |
| | Spray liquor concentration | | |
| | 0.5 g/L ai | | |
| | 12 h | 1 day | 2 days |
| Sharpen ® SC285 + | 0.4 | 0.5 | 0.8 |
| 0.5% AMS | | | |
| (commercial) | | | |
| F1 0.5% (inventive) | 11.1 | 16.6 | 25.6 |

*25° C./56% rel. air humidity
**pear leaf cuticles

The inventive formulation F1 leads to a more than 10-fold increase in the penetration of saflufenacil after 12 hours or 1-2 days.

TABLE 10
Penetration of iodosulfuron (active ingredient
concentration 0.1 g/L in spray liquid)

| | Test product (conc.) | |
|---|---|---|
| | Mean penetration in % after time (n = 4-8) | |
| | Spray liquor concentration | |
| | 0.1 g/L ai | |
| | 1 day* | 2 days h** |
| Husar ® WG20 (commercial) | 7.1 | 8.3 |
| Biopower 0.5% (commercial) | 7.8 | 17.0 |
| F1 0.5% (inventive) | 42.5 | 62.5 |
| Biopower 0.25% PLUS | 23.4 | 41.2 |
| F1 0.15% | | |

*20° C./56% rel. air humidity,
**increase after 1 day to 30° C./56% rel. air humidity

The inventive formulation F1 leads to a more than 6-fold increase in the penetration of iodosulfuron after 1 day or 2 days. This is more than the Biopower standard at the same use concentration of 0.5%, and a combination of the two is likewise better at a concentration of 0.4%.

TABLE 11
Penetration of tembotrione (active ingredient concentration
0.4 g/L in spray liquid) with antagonistic calcium
at 177 ppm Ca, simulating very hard water

| | Test product (conc.) | |
|---|---|---|
| | Mean penetration***** in % after time (n = 4-8) | |
| | Spray liquor concentration | |
| | 0.4 g/L ai | |
| | 12 h* | 1 day** |
| Soberan ® SC420 | <1 | <1 |
| (commercial) *** | | |
| Aureo ® *** 0.25% + | 3.3 | 4.2 |
| 0.1% AMS | | |
| (commercial) | | |
| Raizer ® 0.5% | 1.3 | 1.5 |
| (commercial) | | |
| F4 0.5% (inventive) | 10.1 | 17.6 |
| (commercial) | | |

*20° C./56% rel. air humidity,
**30° C./56% rel. air humidity
*** Soberan ®: Mixture of tembotrione and isoxadifene (Bayer CropScience)
**** Aureo (80% methylated seed oil + 20% emulsifier)
**** pear leaf cuticles

F4 has a water content of nearly 50% and has thus shown, at a use concentration 30% lower than the combination of Aureo and AMS, much better promotion of penetration even with this very hard water.

Raizer® (Farmoz, St Leonards, Australia) is a commercial adjuvant (comprising lecithin, propionic acid and nonionic surfactants) which is used as a “water conditioner”, in order to suppress the antagonistic effects of hard water. F4 is also distinctly superior to this market standard.

### Dynamic Surface Tension (Interfacial Activity)

In the case of plants that are difficult to wet, such as the cereal plants wheat, barley, triticale, rye and oats, in the case of further large-area crops corn, rice, soya and oilseed rape, and also in the case of almost all weed grasses and numerous dicotyledonous weeds that are difficult to control, such as Chenopodium album or Euphorbium heterophyllum, the promotion of the adsorption of the spray liquid on the green parts of the plant is of crucial significance. This wetting agent effect was therefore also determined for the linear C8-C10 glucamide.

For a given application technique or parameters (nozzle, pressure, water application rate, distance from the plant surface), the value for the dynamic surface tension in [mN/m] correlates well with the adhesion on plants that are difficult to wet such as barley (cereal). A value of 50 mN/m (at 20-21° C.) with respect to water (72.8 mN/m) results in an improvement in the adhesion from “zero adhesion” to about 50% (Baur P, Pontzen R 2007. Basic features of plant surface wettability and deposit formation and the impact of adjuvants. In: R E Gaskin ed. Proceeding of the 8th International Symposium on Adjuvants for Agrochemicals. Publisher: International Society for Agrochemical Adjuvants (ISAA), Columbus, Ohio, USA). A value below 60 mN/m at 200 ms gives visibly better adsorption of aqueous spray liquids; in the case of standard flat jet nozzles, optimal wetting is achieved.

Table 12 shows that this value or a lower value is attained even at the low test concentration in water of 1.5 g/L (or 0.8 g/L for the active substance). Thus, the etherified lactate esters are outstandingly suitable for promoting the adsorption of agrochemicals on cereals (with corn, rice, millet/sorghum), banana, cabbage/oilseed rape, soya and other crop plants and harmful plants that are difficult to wet. The positive wetting and sticking effects do of course also apply to other organisms and synthetic surfaces or technical applications, for instance for attainment of thin coatings on or the cleaning of surfaces.

The dynamic surface tension values are shown hereinafter for the linear C8-10 glucamide alone and for some formulations.

TABLE 12
Dynamic surface tension of linear C8/10 glucamide (54%)

Dynamic surface tension (in mN/m)

| Conc. (g/L) | 20 ms | 50 ms | 100 ms | 200 ms |
|---|---|---|---|---|
| 0.3 (0.16) | 72.8 | 72.3 | 71 | 70.4 |
| 1.5 (0.8) | 63.5 | 59.0 | 57.3 | 55.0 |
| 3.0 (1.6) | 55.0 | 50.3 | 47.5 | 45.4 |

| Comparison | Concentration | Dyn. surface tension |
|---|---|---|
| (commercial) | (g/L) | at 200 ms (mN/m) |
| Tallowamine ethoxylates | 1 | 54.1 |
| | 3 | 49.5 |
| Isotridecyl alcohol | 1 | 46.1 |
| ethoxylate | | |

**

TABLE 13
Degree of coverage after spray application
Measurements of the degree of coverage on monocotyledonous plants
such as wheat or, here, Pogonanthera spec. confirm optimal wetting
for a concentration of 0.2% of the linear C8-10 glucamide. This
applies to the pure product and to the formulations F1-F4. By way
of example, the degree of coverage for F1 is shown below with
application by means of a flat jet nozzle in a spray cabin. The
application parameters were XR11002 nozzle (Teejet), spray
pressure 3 bar, 150 L/ha of water; distance from nozzle to
horizontally positioned leaf 45 cm:

| Formulation | Concentration | Degree of coverage [%] |
|---|---|---|
| Water | — | 7.5 |
| F1 | 1 g/L | 28.0 |
| F1 | 2.5 g/L | 57.5 |
| F1 | 5.0 g/L | 78.5 |

The degree of coverage is the area covered by the spray droplets after application on the leaf. A value of 100% corresponds to a continuous film, which is not the aim. The degree of coverage with water was below 5%, and was increased with F1 to 12% at 1 g/L, 30% at 2.5 g/L and 43% at 5 g/L.

### Field Trials

By way of example, the effect of the linear C8/10 glucamide of formulation F1 was examined in field trials at the North Dakota State University by comparison with standards that are in practical use locally and the local standard practical conditions. In the tests, an amount of 360 grams of glyphosate acid as Touchdown® Hitech or per 50 g of mesotrione as Callisto® SC480 per hectare was deployed. The water application rate was 80 liters per ha. A flat jet nozzle was used at 3 bar. The control of the two important local weeds Setaria italica (SETIT) and Amaranthus spp. (AMASS) was scored after 14 days (Jul. 24, 2013) and 28 days (Aug. 8, 2013). The local positive standard is a combination of 10 g/L of the additive R-11® (nonylphenyl ethoxylate, Willbur-Ellis) combined with ammonium sulfate at likewise slightly more than 10 g/L. This was compared with the inventive formulation F1, which was tested at 1.5 g/L and 4.5 g/L.

TABLE 14
Control of the weeds Setaria italica and
Amaranthus spp. with Touchdown ® Hitech
with additives in practical use or inventive F1

| Additive | Conc. | 14 days | | 28 days | |
|---|---|---|---|---|---|
| Standard | g/L | AMASS | SETIT | AMASS | SETIT |
| R- 11 ® | 10 | 88 | 99 | 88 | 95 |
| R- 11 ® + AMS | 10 + 10 | 91.7 | 99 | 90 | 93 |
| F1 | 1.5 | 87 | 99 | 87 | 98 |
| F1 | 4.5 | 90 | 99 | 92 | 96 |

The inventive formulation F1 leads to equally good or better control of the weeds with Touchdown® Hitech than the market/practical standards. At the same time, the composition is much more economically viable, since the use concentration was more than 10 times lower.

TABLE 15
Control of the weeds Setaria italica and
Amaranthus spp. with Callisto ® SC480
with additives in practical use or inventive F1

| Additive | Conc. | 14 days | | 28 days | |
|---|---|---|---|---|---|
| Standard | g/L | AMASS | SETIT | AMASS | SETIT |
| R- 11 ® + AMS | 10 + 10 | 33 | 15 | 33 | 13 |
| F1 | 1.5 | 62 | 18 | 57 | 15 |
| F1 | 4.5 | 53 | 13 | 63 | 13 |

The inventive formulation F1 leads to better control of the weeds with Callisto® SC480 than the market/practical standards. At the same time, the composition is much more economically viable, since the use concentration is 4 to 10 times lower.

1. An adjuvant composition comprising
a) at least one alkylglucamide of the formula (I) 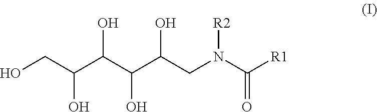
in which
R1 is a linear or branched alkyl group having 5 to 9 carbon atoms,
R2 is an alkyl group having 1 to 3 carbon atoms,
b) at least one water-soluble ammonium salt,
c) propylene glycol, dipropylene glycol, mixtures of propylene glycol and dipropylene glycol, each optionally in a mixture with polypropylene glycol and/or polyethylene glycol, each having up to ten repeat units, and
d) water.

2. The adjuvant composition as claimed in claim 1, wherein R1 is a linear or branched alkyl group having 7 to 9 carbon atoms and R2 is a methyl group.

3. The adjuvant composition as claimed in claim 1, which is a mixture of octyl-N-methylglucamide R¹═C₇-alkyl and decyl-N-methylglucamide R═C₉-alkyl or nonyl-N-methylglucamide, R¹═C₈-alkyl.

4. The adjuvant composition as claimed in claim 1, wherein the proportion of the at least one alkylglucamide a) is 10% to 90% by weight, based on the total weight of the composition.

5. The adjuvant composition as claimed in claim 1, wherein the ammonium salt b) is selected from the group consisting of ammonium sulfate, ammonium nitrate, ammonium nitrate urea, ammonium phosphate, ammonium citrate, ammonium chloride and ammonium thiosulfate.

6. The adjuvant composition as claimed in claim 1, wherein component c) is propylene glycol.

7. A method for enhancing the biological activity of pesticides, comprising the step of adding at least one adjuvant composition comprising
a) at least one alkylglucamide of the formula (I) 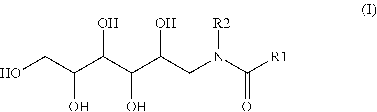
in which
R1 is a linear or branched alkyl group having 5 to 9 carbon atoms,
R2 is an alkyl group having 1 to 3 carbon atoms,
b) at least one water-soluble ammonium salt,
c) propylene glycol, dipropylene glycol, mixtures of propylene glycol and dipropylene glycol, each optionally in a mixture with polypropylene glycol and/or polyethylene glycol, each having up to ten repeat units, and
d) water to the pesticide.

8. A method for producing an aqueous pesticide composition comprising the step of adding at least one adjuvant composition comprising
a) at least one alkylglucamide of the formula (I) 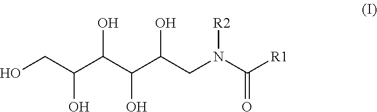
in which
R1 is a linear or branched alkyl group having 5 to 9 carbon atoms,
R2 is an alkyl group having 1 to 3 carbon atoms,
b) at least one water-soluble ammonium salt,
c) propylene glycol, dipropylene glycol, mixtures of propylene glycol and dipropylene glycol, each optionally in a mixture with polypropylene glycol and/or polyethylene glycol, each having up to ten repeat units, and
d) water to the aqueous pesticide composition.

9. A pesticide composition comprising
a) at least one alkylglucamide of the formula (I) 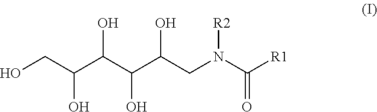
in which
R1 is a linear or branched alkyl group having 5 to 9 carbon atoms,
R2 is an alkyl group having 1 to 3 carbon atoms,
b) at least one ammonium salt,
c) propylene glycol, dipropylene glycol, mixtures of propylene glycol and dipropylene glycol, each optionally in a mixture with polypropylene glycol and/or polyethylene glycol, each having up to ten repeat units,
d) water,
e) optionally at least one cosolvent,
f) optionally at least one auxiliary,
g) at least one water-soluble pesticide,
h) optionally at least one water-insoluble pesticide.

10. The pesticide composition as claimed in claim 9, wherein the one or more water-soluble pesticide(s) of component g) are selected from the group consisting of herbicides.

11. The pesticide composition as claimed in claim 9, wherein the at least one water-soluble pesticide of component g) is selected from the group consisting of water-soluble salts of 2,4-D, bentazon, dicamba, fomesafen, glyphosate, glufosinate, MCPA, mesotrione, paraquat and sulcotrione.

12. The pesticide composition as claimed in claim 9, which comprises one or more water-insoluble active ingredients.

13. The pesticide composition as claimed in claim 9, wherein the total amount of the pesticides of component g) in the composition is greater than 100 g/L based on the acid equivalent thereof.

14. The pesticide composition as claimed in claim 9, wherein the total amount of the alkylglucamides of the formula (I) in the composition is from 20 to 250 g/L.

15. The pesticide composition as claimed in claim 9, wherein the content of the one or more ammonium salts b) is 10 to 500 g/L, based on the overall composition.

16. The pesticide composition as claimed in claim 9, wherein the composition comprises, one or more further adjuvants.

17. The pesticide composition as claimed in claim 9, which takes the form of a concentrate formulation which is diluted prior to use and contains 5% to 80% by weight, of the at least one water-soluble pesticide of component g) and 1% to 25% by weight, of the at least one alkylglucamide of component a).

18. The pesticide composition as claimed in claim 9, which takes the form of a spray liquor and comprises 0.001% to 10% by weight, of the at least one water-soluble pesticide of component g) and 0.01% to 1° A by weight, of the at least one alkylglucamide of component a).

19. A method for control and/or for abatement of unwanted plant growth, fungal disorders or insect infestation in plants comprising the step of contacting the unwanted plant growth, fungal disorders or insect infestation in plants with a pesticide composition comprising
a) at least one alkylglucamide of the formula (I) 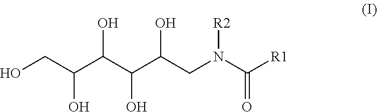
in which
R1 is a linear or branched alkyl group having 5 to 9 carbon atoms,
R2 is an alkyl group having 1 to 3 carbon atoms,
b) at least one ammonium salt,
c) propylene glycol, dipropylene glycol, mixtures of propylene glycol and dipropylene glycol, each optionally in a mixture with polypropylene glycol and/or polyethylene glycol, each having up to ten repeat units,
d) water,
e) optionally at least one cosolvent,
f) optionally at least one auxiliary,
p) at least one water-soluble pesticide,
h) optionally at least one water-insoluble pesticide.

20. A method of protecting plants from harmful organisms, wherein the plant, the harmful organisms or their habitat is brought into contact with a pesticide composition comprising an inventive adjuvant composition comprising
a) at least one alkylglucamide of the formula (I) 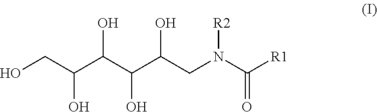
in which
R1 is a linear or branched alkyl group having 5 to 9 carbon atoms,
R2 is an alkyl group having 1 to 3 carbon atoms,
b) at least one water-soluble ammonium salt,
c) propylene glycol, dipropylene glycol, mixtures of propylene glycol and dipropylene glycol, each optionally in a mixture with polypropylene glycol and/or polyethylene glycol, each having up to ten repeat units, and
d) water.
